(19) United States
(12) Patent Application Publication
(10) Pub. No.: US 2007/0279806 A1
(43) Pub. Date: Dec. 6, 2007

(54) Drive actuator having a four-bar flexure moving-magnet motor system

(75) Inventor: John A. Ycas, Boulder, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/445,546

(22) Filed: Jun. 2, 2006

(51) Int. Cl. G11B 5/55

(52) U.S. Cl. 360/261.1

(57) ABSTRACT

In one example, a drive head actuator includes a base, a positioner, and a planar coil. The positioner includes a frame movably attached to the base and having a data transducer head and at least one permanent magnet fixed thereto. The planar coil is fixed to the base and has a major surface disposed adjacent the at least one permanent magnet and substantially parallel to support surface of the data transducer head. The frame is operable to move relative to the base and planar coil in response to energizing the planar coil. Additionally, the positioner may be attached to the base via two flexures, which are relatively flexible in a plane of flexion and stiff in other planes.

### BACKGROUND

1. Field

The invention relates generally to data storage systems, and in one example, to a fine positioner of a head actuator for use in a data storage drive.

2. Related Art

In the magnetic data tape storage industry, for example, data is stored on magnetic tapes in multiple parallel, longitudinal tracks. Tape drives write data to and read data from these tapes using a read/write head. The read/write head has a plurality of data read/write elements to access multiple tracks simultaneously, but the number of tracks is generally greater than the number of read/write elements that are fabricated on a read/write head. Accordingly, an actuator in the tape drive moves the head transversely to the tape surface to read and/or write data on the tracks as the tape moves past the head in a longitudinal direction.

Additionally, as the tape moves relative to the tape head, lateral tape motion may occur, wherein the tape moves transversely to the direction of tape transport. Accordingly, as the tape moves laterally relative to the head, the actuator moves the head in an attempt to maintain the read/write elements aligned with the data tracks of the tape. Lateral tape motion may include relatively fast, unpredictable changes in position, for which the actuator may include a fine positioner to compensate for such movements and maintain proper track alignment. The system may detect and move the positioner, for example, in response to control signals and servo signals generated in response to a detection of magnetic and/or optical servo track associated with the tape, detection of the media edge, combinations thereof, and the like.

Further, it is generally desirable that the fine positioner of the actuator have a first or fundamental resonance frequency that is relatively low, commonly below 250 Hz. Further, in an attempt to improve tracking capability of the drive, the next, i.e., higher order, resonance(s), sometimes referred to herein as resonant frequencies, is desirably sufficiently high such that the servo control system can accurately follow the tracks and dismiss disturbances in the tape motion. The resonances and mode shapes, i.e., the three dimensional motion of the positioner at the resonant frequencies, generally depend on the shape and structure of the actuator. Higher order resonances generally degrade the ability of the positioner to track movements of the tape and keep the head centered on the tracks to be written or read. Therefore, the higher order resonances may limit how narrow the data tracks can be recorded on the tape. Since the track size directly affects the data storage capacity of the tape, the resonances are a critical factor affecting tape storage capacity. Increasing the frequency of the resonances to well above the servo control system bandwidth may allow for recording smaller tracks and reading from smaller tracks, thereby increasing the storage capacity.

Accordingly, it is desired to provide an actuator that is well balanced such that the actuator, and in particular, the fine positioner, may operate at high servo bandwidths. Additionally, it is desired that the actuator have a simple construction with high durability and life.

### SUMMARY

In one aspect of the present invention a drive head actuator for positioning a transducer head for accessing data stored on a storage medium is provided. In one example, the drive head actuator includes a base, a positioner, and a planar coil. The positioner includes a frame movably attached to the base and having a data transducer head and at least one permanent magnet fixed thereto. The planar coil is spatially fixed with respect to the base and has a major surface disposed adjacent the at least one permanent magnet and substantially parallel to a support surface of the data transducer head (or alternatively, substantially parallel to a direction of tape transport relative to a portion of the data transducer head). The frame is operable to move relative to the base and planar coil in response to energizing the planar coil, resulting in magnetic forces between the planar coil and the permanent magnet.

The actuator may further include two flexure members attaching the frame to the base in a movable relationship. For example, two flexure members may be disposed on opposite sides of the positioner to allow the positioner to move in a first direction, generally laterally with respect to the direction of tape transport, and restrict or inhibit motion in other directions, e.g., along the direction of tape transport.

In one example, the planar coil is disposed at least partially at the center of mass of the positioner (e.g., of the moving portions including the frame, head, magnet, etc.). In one example, the planar coil is operable to produce a magnetic field substantially aligned with the center of mass of the positioner (in one example, the center of the magnetic field produced by the coil is within 0.3 inches of the center of mass). In yet another example, the center of mass of the positioner is located at the intersection of two axes, the two axes defining a plane substantially parallel to the major surface of the coil, and a third axis passes through the center of mass of the positioner, is perpendicular to the plane, and is substantially aligned with the direction of magnetic force produced by the planar coil when energized.

In another example, a tape head actuator is provided. The tape head actuator includes a base, a tape head positioner attached to the base by first and second flexures, and a planar coil. The tape head positioner generally includes a tape head operable to access a tape (e.g., read, write, or both), and at least one permanent magnet fixed with respect to the tape head. The planar coil is attached to the base and positioned having a major surface substantially parallel to a support surface of the tape head. Further, the first flexure is positioned to a first side of the coil, having a proximal end attached to the base and a distal end attached to the positioner, and the second flexure positioned to a second side of the coil, having a proximal end attached to the base and a distal end attached to the positioner. The positioner is operable to move relative to the base in response to energizing the planar coil (e.g., providing a sufficient current through the planar coil).

In one example, the planar coil is disposed at least partially at the center of mass of the positioner (e.g., of the moving portions including the frame, head, magnet, etc.). In one example, the planar coil is operable to produce a magnetic force substantially aligned with the center of mass of the positioner (in one example, the center of the magnetic force produced by the coil is within 0.3 inches of the center of mass). In yet another example, the center of mass of the positioner is located at the intersection of two axes, the two axes defining a plane substantially parallel to the major surface of the coil, and a third axis passes through the center of mass of the positioner, is perpendicular to the plane, and is substantially aligned with the direction of magnetic force produced by the planar coil when energized.

The various aspects and examples of the present inventions are better understood upon consideration of the detailed description below in conjunction with the accompanying drawings and claims.

### BRIEF DESCRIPTION

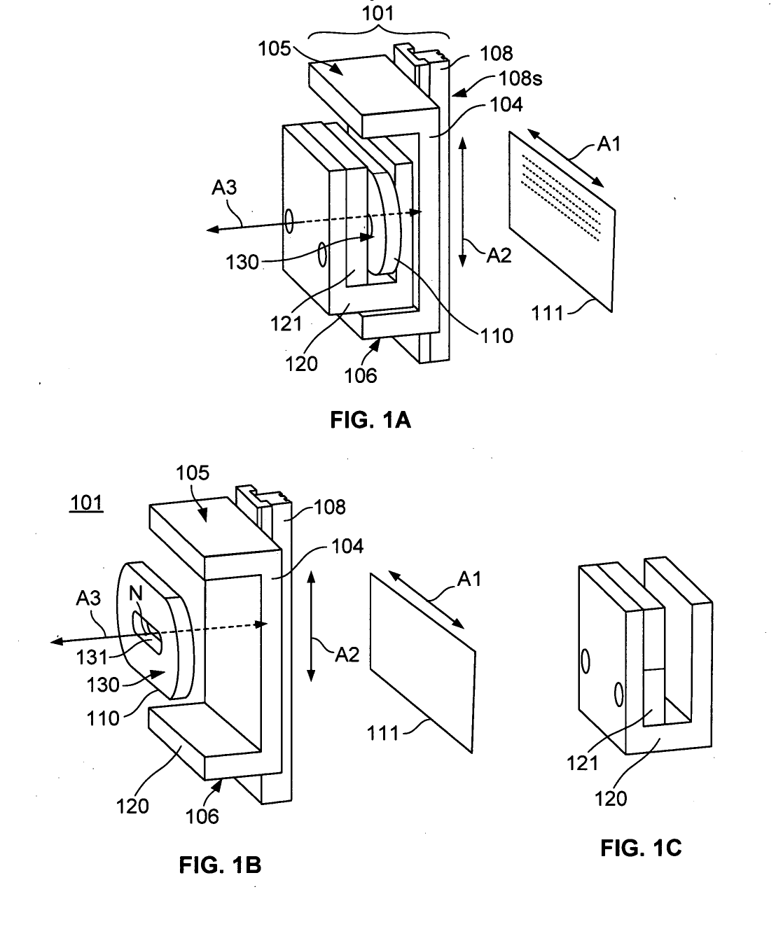

FIG. 1A illustrates a perspective view of a portion of a fine positioner of a tape head actuator according to one example.

FIG. 1B illustrates a perspective view of a portion of the fine positioner (e.g., absent the magnet) according to the example shown in FIG. 1A.

FIG. 1C illustrates a perspective view of a magnet holder and magnet according to the example shown in FIG. 1A.

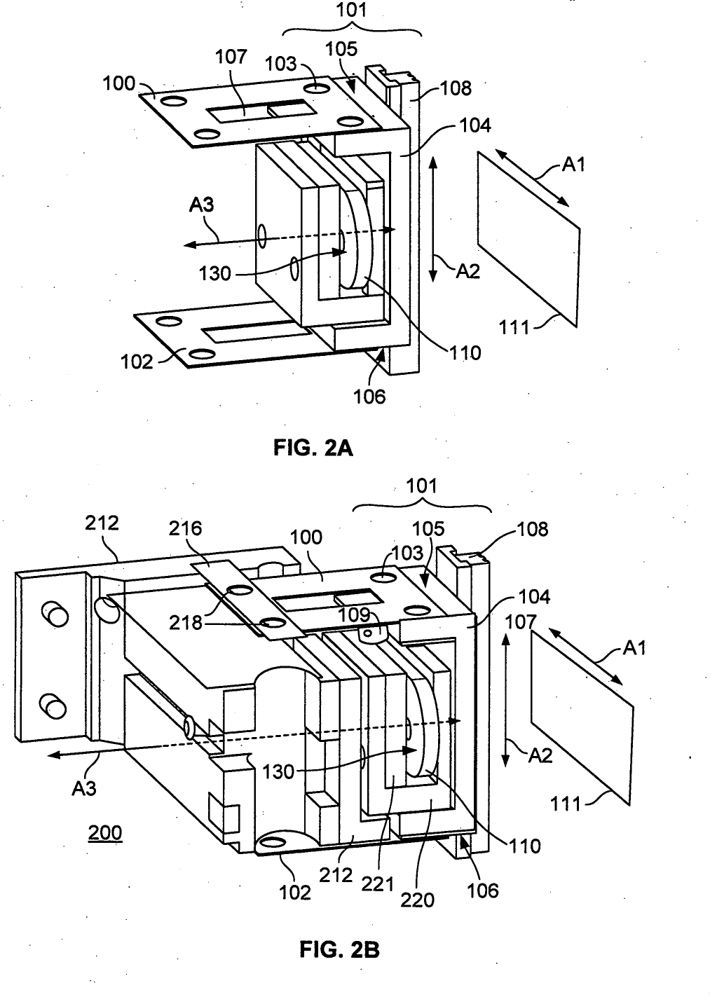

FIG. 2A illustrates a perspective view of a portion of the fine positioner shown in FIG. 1A, having attached flexures according to one example.

FIG. 2B illustrates a perspective view of a tape head actuator including the fine positioner of FIG. 1A according to one example.

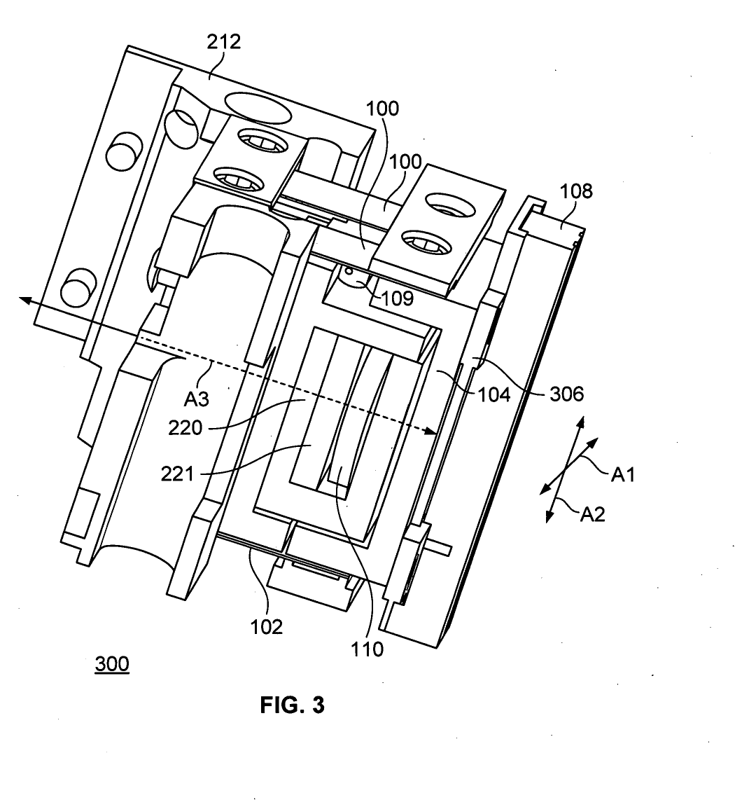

FIG. 3 illustrates a side perspective view of a tape head actuator according to another example.

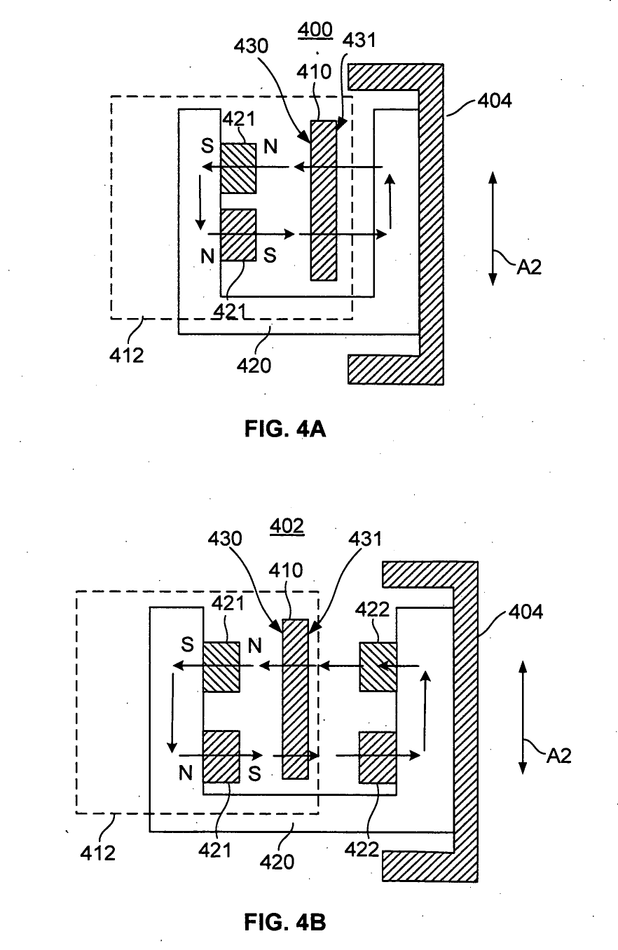

FIGS. 4A and 4B illustrate side views of fine positioner motor systems according to additional examples.

### DETAILED DESCRIPTION

The following description is presented to enable a person of ordinary skill in the art to make and use the various inventions, and is provided in the context of particular applications and examples. Various modifications to the examples will be readily apparent to those skilled in the art, and the generic principles defined herein may be applied to other examples and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the examples shown and described, but is to be accorded the widest scope consistent with the principles and features disclosed herein.

For ease of explanation, the examples are described generally with respect to a magnetic storage tape drive actuator and fine positioner system thereof. It will be appreciated by those of ordinary skill in the art that the examples may be applied (with appropriate modifications) to other data storage systems such as optical, magnetic, or magnetic-optical storage systems.

In one example, a fine positioning system is described that may operate at high servo bandwidths by having a balanced assembly, for example, where the center of the motor force acting on the moving portion of the assembly is substantially through or aligned with the center of mass of the moving portion of the assembly. In one example, the moving portion includes a support frame holding a magnet assembly (including, e.g., at least one permanent magnet and a magnet holder) and a data transducer head. The frame is operable to move relative to a stationary planar coil attached to a base or stationary portion of the actuator. In one example, a major surface of the planar coil is positioned substantially parallel to a supporting surface of the data transducer head.

Aligning the center of the motor force with the moving portion of the positioner may reduce torques thereon and improve performance and operating bandwidth of the system. In one example, the coil is positioned at or near the center of mass of the moving portion of the positioner, and when activated generates a magnetic field and force on the permanent magnet substantially aligned with the center of mass. Additionally, utilizing a stationary coil (as opposed to a moving coil) may simplify the assembly as well as improve the durability and life of the assembly as movement and flexing of the coil or leads to the coil is reduced or eliminated during operation.

FIGS. 1A-1C and 2A-2B illustrate various views and aspects of an exemplary fine positioner 101 and actuator 200 according to one example. Accordingly, the figures are advantageously referenced in combination with the following description. With reference initially to FIG. 1A, a perspective view of a portion of an exemplary fine positioner 101 of an actuator assembly is shown. Fine positioner 101 includes a head mounting frame 104, a data transducer head 108, a magnet holder 120, and a magnet 121 (which includes at least one permanent magnetic element), and is configured for use as part of a tape head actuator in a tape drive (not shown). A coil 110 is positioned adjacent magnet 121, and in this example between magnet 121 and frame 101, at or near the center of mass of positioner 101.

In operation, positioner 101, including tape head 108 and magnet 121 attached to head mounting frame 104, moves relative to stationary coil 110 in response to magnetic fields produced by coil 110, resulting in a magnetomotive force exerted on magnet 121. In particular, magnet 121 and coil 110 are configured in a fashion such that upon the application of sufficient electrical current to coil 110, a force is generated therebetween causing relative movement between magnet 121 and coil 110. In this example, coil 110 is held stationary, for example, with respect to a base of the actuator (see, e.g., FIG. 2B), such that magnet 121 and positioner 101 move in response to energizing coil 110.

The data transducer head 108 includes a support surface 108s for supporting and engaging tape 111 as passes adjacent at least one data transducer element formed therewith, e.g., read or write elements, for reading from or writing to tape 111. Head 108 may include read/write transducer elements, and tape 111 may include a magnetic data storage tape. Accordingly, a controller (not shown) may energize coil 110 with an appropriate magnitude and polarity/direction of current to generate a desired magnetic force and movement of positioner 101, thereby positioning head 108 and associated transducer elements at a desired location relative to head 111. In particular, positioner 101, including head 108, moves in response to changing current applied to coil 110, generally along axis A2 to access (e.g., read/write) tracks of storage medium 111 during operation.

In this example, magnet 121 is disposed adjacent coil 110 (but not necessarily without an interposed element). Magnet 121, which may include one or more permanent magnets positioned adjacent each other, includes a major surface adjacent, and substantially parallel, to major surface 130 of coil 110. Magnet 121 may be held by a magnet holder 120, which wraps partially or fully around coil 110. In this example, magnet holder 120 is configured to hold magnet 121 at a suitable position such that the center of mass of the moving portions of positioner 101 (other than coil 110) is located at or near the position of the center of coil 110, or at least at or near the center of a magnetic field generated by coil 110. In this manner, the motor force generated by coil 110 is generally aligned with the center of mass of positioner 101. Such an arrangement, e.g., with the center of motor force through the center of mass of positioner 101, may provide a balanced assembly with reduced torques (and without exciting resonances of positioner 101 during operation).

Coil 110 includes, for example, an insulated conductive wire, e.g., a copper wire, wrapped in a spiral shape to form a multi-turn, flat, rectangular coil with two rounded sides, two flat sides, and a major surface 130. Major surface 130 of coil 110 is substantially parallel to a plane defined by the axes A1 and A2. Axes A1 and A2 further generally relate to a plane of tape 111 as it engages supporting surface 108s of data head 108. It will be recognized, of course, that contoured heads, for example, engage tape 111 as it wraps or curves on a contoured surface thereof; accordingly, in one example, it may be stated that major surface 130 of coil 110 is substantially parallel to a portion of support surface 108s of head 108, or alternatively that major surface 130 of coil 110 is substantially parallel to a direction of tape transport over at least a portion of head 108, generally defined by axis A1. It is also noted that the support surface of head 108 does not necessarily physically contact tape 111, e.g., a thin layer of air may be present there between, such that engaging may include supporting tape 111 as it steams by via an air lubricated interface with tape 111.

For illustrative purposes only, the dimensions of an exemplary coil 110 are as follows. The upper and lower flat surfaces of the coil 110 are 0.413 inches in length (i.e., along axis A1). The outer radius of each rounded side of the coil is 0.157 inches. The width of the coil is 0.314 inches (along axis A2) and the overall length of the coil is 0.728 inches (along axis A1; the sum of 0.413, 0.157, and 0.157). The thickness of the coil is 0.049 inches (along axis A3). The coil 110 includes a slot 131, which is an empty area that has an inside surface around which internal windings (not shown) of the coil may be wound. The width of the slot 131 is 0.079 inches (along axis A2). Other examples of the coil 110 may have different dimensions depending, e.g., on the particular application, actuators, mass, center of mass of positioner 101, and so on.

FIG. 1B illustrates a perspective view of fine positioner 101 adjacent coil 110 and with the magnetic holder 120 and magnet 121 removed (shown separately in FIG. 1C) for illustrative purposes. When electric current is applied to coil 110 in a first direction, a north magnetic pole N is present at one end of the opening of coil 110, and a south magnetic pole S (not shown) is present at the other end of, i.e., on the reverse side of, of the opening of coil 110. The locations of the north pole N and south pole S are determined by windings (not shown) in the coil 110, the properties of the windings when electric current passes through the windings, and the direction or polarity of current, as is known to those skilled in the art.

An axis A3 is shown passing generally through the north pole N and south pole S of coil 110. The axis A3 is generally perpendicular to a plane of tape 111, of which the axes A1 and A2 are parallel to. Accordingly, in this example, the major surface 130 of coil 110 is substantially parallel to a supporting surface of head 108 and the direction of tape transport relative to a portion of head 108. Thus, the major surface of coil 110 is substantially parallel to the plane defined by the axes A1 and A2.

In one example, coil 110 is positioned relative to moving portions of fine positioner 101, and more particularly, relative to head 108, magnet 121, and associated structures such as magnetic holder 121 and frame 104, such that the motor force generated by coil 110 is positioned at or aligned substantially with the center of mass of fine positioner 101, or at a relatively small distance from the center of mass of fine positioner 101. The small distance may, for example, allow for structural members between coil 110 and head 108. The term “aligned” is used herein to indicate that the center of motor force generated by coil 110, via the interaction of coil 110 current when energized and the magnet field set-up by the magnet 121, is positioned relative to the center of mass of fine positioner 101 within a predetermined distance and at a predetermined three-dimensional offset. The center of mass is a close approximation to the actual center of mass of the fine positioner 101, because, e.g., the parts of the positioner 101 have tolerances which may cause the exact center of mass to be different from the nominal center by some small amount, and positioner 101 is moving during operation and may only be aligned during a portion of the movement.

In one example, coil 110 and/or the center of magnetic force generated by coil 110 is disposed at or near the center of mass of fine positioner 101 in two of the three spatial dimensions, e.g., at or near zero offset. In one example, the centers are separated by a small distance, e.g., 0.3 inches or less, in the third dimension. In another aspect, the center of force of the coil 110 is at a predetermined spatial offset from the center of mass of the fine positioner 101, e.g., at an offset of 0.3 inches or less in a first dimension, an offset of 0.01 inches or less in a second dimension, and an offset of 0.01 inches or less in a third dimension.

FIG. 1C is a perspective view of magnet holder 120 and magnet 121 according to one example. Generally magnetic holder is configured to position magnet 121 (which may include two or more magnets) at a position separated from frame 104 such that coil 110 may be disposed therebetween, near the center of mass of positioner 101. In this example, magnet holder 120 is adapted to wrap partially or fully around magnet 121, and magnet 121 is mounted on magnet holder 120. In other examples, magnetic holder 121 may be formed integrally with frame 104. Magnet holder 120 and magnet 121

Magnet holder 120 (or a portion of holder 104 engaging magnetic 121) may include a ferrous or ferromagnetic material, e.g., steel or the like, and may serve as a magnetic flux conducting structure (for forming a magnetic circuit). Magnet 121 may include any suitable magnetic material such as a rare earth magnetic material. Additionally, magnet 121 may include any number of permanent magnets, for example, a two-pole magnet or a four-pole magnet, as described in greater detail with respect to FIGS. 4A and 4B. Further, magnet 121 generally defines a major surface that is positioned adjacent to and substantially parallel to major surface 130 of coil 110.

The magnet 121 is positioned adjacent to the major surface 130 of the coil 110, so that magnet holder 121 wraps partially or fully around coil 110. As described, fine positioner 101 is movable relative to coil 110. In one example, fine positioner 101 is not attached to coil 110. That is, neither magnetic holder 120, magnet 121, nor the frame 104 is attached directly to coil 110. In one example, fine positioner 101 is attached to coil 110 in a fashion allowing for relative movement of fine positioner 101 (including frame 104, magnet 121, and head 108) and coil 110 as generally described herein.

FIG. 2A illustrate a perspective view of a fine positioner 101 with attached flexures 101 and 102 according to one example. Generally, flexures 100 and 102 are configured to allow motion, e.g., flexure, in one dimension and be relatively stiff in other dimensions. In this example, an upper flexure 100 and a lower flexure 102 are attached to the head mounting frame 104 and are positioned on opposite sides of coil 110. Each flexure is relatively flexible along A2 and relatively stiff in other dimensions, e.g., A2 and A3. The plane in which flexures 100 and 102 are flexible is referred to herein as the plane of flexion; the major surfaces of flexure 100 and 102 correspond to the flexure's plane of flexion. Flexures 100 and 102 allow fine positioner 101 (including head 108) to move a limited distance along the A2 axis, and substantially perpendicular to the flexures' planes of flexion. Since flexures 100 and 102 are relatively stiff in other directions, the fine positioner 101 is generally inhibited from moving substantially in the directions of axes A1 and A3.

In this example, the distal end of upper flexure 100 is attached to a top side 105 of head frame 104 and extends substantially perpendicularly from head frame 104. The distal end of the lower flexure 102 is attached to a bottom side 106 of the head frame 104 and extends substantially perpendicularly from the head frame 104. In this example, flexures 100 and 102 are substantially perpendicular to major surface 130 of coil 110. Further, flexures 100 and 102 are substantially parallel to axis A3 passing through the magnetic poles of the coil 110 when current is applied thereto, e.g., through the center of coil 110 as shown in FIG. 1B.

In one example, flexures 100 and 102 are formed from a thin sheet of metal. In other examples, flexures 100 and 102 may include any suitable flexible material with elastic properties, such as a flat spring or flat members connected by a spring-loaded hinge. In one aspect, each of the flexures 100 and 102 includes a void, such as a rectangular hole in the center of the flat surface of the flexure. In one aspect, each flexure 100 and 102 has a rectangular void 107, which divides the flexures 100 and 102 into two longitudinal bar regions. Each rectangular flexure 100 and 102 is, for example, 0.512 inches in width (i.e., along axis A1) by 0.551 inches in length (along axis A3) by 0.003 inches in thickness (along axis A2). The thickness of each flexure 100 and 102 may be between 0.002 inches and 0.005 inches (along axis A2). It will be recognized, of course, that flexures 100 and 102 may have various dimensions depending, e.g., on the particular application, design considerations, cost considerations, and the like. Further, the upper flexure 100 need not include the same materials or dimensions as the lower flexure 102.

In operation, an electric current applied to coil 110 moves fine positioner 101 along the axis A2, the motion constrained by flexures 100 and 102 as described herein. For example, as tape 111 moves past head 108 in a direction substantially parallel to an axis A1, the high out-of-plane stiffness of flexures 100 and 102 allows fine positioner 101 to move and follow lateral tape motion of tape 111 (e.g., lateral tape motion, along axis A2), while reducing out-of-plane motions caused by natural resonances in frequency ranges that may influence the tracking system. The flow of electric current through coil 110, which is in the magnetic field created by magnet 121, generates a force which moves magnet 121 and consequently fine positioner 101, including the head 108, in a direction substantially parallel to the axis A2 (e.g., there is or may be some rotational motion depending on the distance moved).

FIG. 2B is a perspective view of an exemplary head actuator 200, including exemplary positioner 101. Head actuator 200 is configured for use with a tape drive (not shown). Head actuator 200 includes fine positioner 101 attached to a base 212 by flexures 100 and 102 as described, and a stationary coil 110 also attached to base 212. The base 212 may be, for example, a coarse positioner body, which moves relative to another object, such as a tape drive. A proximal end of each flexure 100 and 102 is attached to the base 212, and a distal end of each flexure 100 and 102 is attached to a head mounting frame 104 of the fine positioner 101. The base 212 moves parallel to the axis A2, transverse to the direction of transport of tape 111, to read and write data on longitudinal tracks of tape 111. The base 212 is in a fixed spatial relationship with coil 110, which selectively produces a magnetic field in the vicinity of magnet 221 as described previously. The magnetic field produces a magnetic force sufficient to precisely move and position head 108 by relatively small distances along the transverse axis A2. Flexures 100 and 102 allow the head 108 to move parallel to the transverse axis A2 with little to no hysteresis. The flexures 100 and 102 hold the fine positioner 101, which includes the head 108, in a substantially fixed position in other directions, relative to the base 112 (e.g., along the axes A1 or A3).

The position of coil 110 between the flexures 100 and 102 and in close proximity to the center of mass of the positioner 101 allows the actuator servo control system to operate at high frequencies, e.g., above 800 Hz, because the center of force produced by the coil is located at or near the center of mass of fine positioner 101. Further, the particular arrangement of this example may reduce torques on the fine positioner 101 because coil 110 is at or near the center of mass of positioner 101 and the relative stiffness of the flexures 100 and 102 in the axes normal to the axis A2. In one aspect, the coil 110 is positioned relative to frame 104, head 108, and magnet 121 such that the center of force of the coil 110 is located at or near the center of mass of the fine positioner 101. The mounting attachment may be secured by screws or other fasteners, and may include plates, e.g., a plate 216, to hold the flexures against the frame 104. Alternatively, some or all of the components, including coil 110, head 108, and flexures 100 and 102 may be integrally formed in a single assembly.

Coil 110 is attached to and stationary with respect to base 212 (or another portion of actuator 200) such that positioner 101 moves relative to coil 110 and base 212. Coil 110 may be electrically connected via wires attached to a fixed flex lead, wire bundle, or the like. Because coil 110 is stationary with respect to base 212, the durability and life of the connection of coil 110 may be improved over existing actuator assemblies where such leads are flexible and move with movement of coil 110.

In this example, coil 110 is positioned between upper flexure 100 and lower flexure 102, and the plane of the flat side of the coil 110 is substantially perpendicular to the upper flexure 100 and the lower flexure 102. That is, the flat side of the coil 110 is typically at a 90 degree angle to the flexures, but other orientations are possible. In other examples, however, flexures may extend at non-right angles from the coil, or the coil may be positioned at a slightly non-right angle.

Base 212 is spaced apart from the head frame 104, and the upper flexure 100 and the lower flexure 102 are affixed to the base 212, e.g., by screws 218 which secure the mounting plate 216 against the upper flexure 100. In another example, the upper flexure 100 and the lower flexure 102 may be integrally formed upon the head frame 104 or base 212.

In one example, a position sensor 109 may be mounted on the base 212 to monitor the position of a portion of positioner 101, e.g., support frame 104, with respect to the base 212. Position information from the position sensor 109 may be used by a drive controller (not shown) to maintain the position of head 108 during shock events. The position sensor 109 may be, for example, an optical interrupter, a miniature Hall-effect sensor, and inductive sensor, or the like. During a mechanical shock event the head 108 and frame 104 may move before the servo system can detect that the head 108 is moving off track. The sensor 109 provides feedback which can be used to correct the position of head 108, e.g., by generating or adjusting a current in coil 110 to move frame 104 and position head 108 in response to the detected movement.

FIG. 3 illustrates a side perspective view of a tape head actuator 300 according to another example. Head actuator 300 is similar to head actuator 200 of FIG. 2, with the addition of an intermediate head adapter 306, which is positioned between head 108 and head mounting frame 104. Head adapter 306 is generally used during manufacturing for building or attaching head 108 thereto. The example of FIG. 3, otherwise is similar to that of FIG. 2.

FIGS. 4A and 4B illustrate side views of a portion of a positioner 400 and 402 according to further examples, and in particular, to illustrate the magnetic forces between a planar coil and magnet assembly. With reference to FIG. 4A, positioner 400 generally includes a coil 410 (e.g., similar to coil 110 described above) and one or more permanent magnets 421 forming a moving magnet assembly, and which together form a magnetic circuit when coil 410 is energized. In this example, positioner 400 includes two magnets 421 attached to an inner surface of magnet holder 420, which is in turn attached to frame 404. Further, coil 410 is attached to a base 412 (shown in outline for illustrative purposes), coil 410 positioned in proximity of magnets 421.

The moving magnet assembly of magnets 421 may include one or more magnets, including an arrangement of two or four-pole magnets, for example. In the present instance, a four-pole magnet (having two north poles and two south poles) is shown FIG. 4A, including an arrangement of two magnets 421. Magnets 421 are positioned to provide a magnetic field in a direction substantially perpendicular to at least a portion of the major surfaces 430 and 431 of coil 410, as indicated generally by arrows shown in FIG. 4A (note, the arrows relating to the magnetic field produced by magnets 421 are illustrative only).

When current flows through coil 410, a magnetic field is created, which interacts with the magnet field of magnets 421 and results in a force and relative movement of magnets 421 and frame 404 relative to coil 410. For example, applying current through coil 410 in a first polarity. or direction results in a magnetic force on magnets 421 and frame 404 in a first direction (along axis A2); conversely, applying current through coil 410 in a second polarity or direction results in a magnetic force on magnets 421 and frame 404 in a second direction, opposite from the first direction. Accordingly, varying the polarity and magnitude of current through coil 410 provides varying forces and displacement of frame 404 relative to coil 410.

For example, if current is applied through coil 410 in a fashion to set-up a magnetic field corresponding to a north pole positioned at the surface 430 of coil 410 facing magnets 421, magnets 421 and frame 404 would be forced up (e.g., the generated north pole of coil 410 attracting the south pole S of lower magnet 421 and repelling the north pole N of upper magnet 421). Reversing the current through coil 410 results in the force acting in the opposite direction. In other examples, a single permanent magnet 421 could be used, offset from the center for the magnetic field generated by coil 410.

FIG. 4B is a side view of a fine positioner 402 according to another example. The positioner 402 forms a magnetic circuit and is similar to positioner 400 of FIG. 4A, except that positioner 402 includes additional magnets 422 on an opposite side of coil 410 as magnets 421. Magnets 422, in addition to magnets 421, may increase the magnetic field and forces generated when coil 410 is activated. Additionally or alternatively, magnets 422 may assist in balancing the mass of, and force acting on, moving portion of positioner 402.

Magnets 421 and 422 each have a north pole N and a south pole S and are positioned generally to provide a magnetic field in a direction substantially perpendicular to the major surfaces 430 and 431 of coil 410. The magnetic field is shown in FIG. 4B as arrows directed through the poles of the magnets 421 and 422 (again, the magnetic field arrows are illustrative only). When current flows through coil 410, the resulting magnetic forces on magnets 421 and 422 cause frame 404 to move generally along axis A2.

It is noted, that the term “substantially” as used herein to indicate an approximation of a perpendicular or parallel orientation (with respect to any of the examples) does not require an absolute perpendicular or parallel orientation. In one example, a substantially perpendicular or parallel orientation includes within plus or minus 15 degrees of perpendicular or parallel, and in one example, within 5 degrees of perpendicular or parallel. Accordingly, in one example, coil 130 is described as being substantially parallel to the plane of tape 111 defined by the axes A1 and A2 (at the point where tape 111 passes over head 108) or to the axes A2. The term “substantially” indicates that the coil 130 may be oriented parallel to, i.e., at an angle of 0 degrees to, the plane of the tape 111, or at an angle of up to plus or minus 15 degrees to the axis A1 or to the axis A2, or at up to plus or minus 15 degrees of each axis A1, A2. The 0 degree angle is shown in the figures and is used here for illustrative purposes of one instance. To illustrate the term “substantially perpendicular”, the upper flexure 100 may be perpendicular, i.e., at a 90 degree angle, to the head frame 104, or may be at some other angle within approximately 15 degrees of a right angle, e.g., 75 degrees. The 90 degree angle is shown in the figures and is used for illustrative purposes. However, the flexures may be at others angles to the head frame. Angles other than 90 degrees may cause the flexures to impart a tip of the head 108 into and out of the plane of the tape 111 as the head 108 moves along the axis A2. Therefore, the angle is typically 90 degrees, or close to 90 degrees, e.g., 85 or 95 degrees.

Although various aspects of the invention have been described in connection with some specific embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is therefore not to be limited by the foregoing illustrative details, but is to be defined according to the claims.

What is claimed is:

1. An actuator for positioning a head relative to data storage tape, comprising:
a base;
a positioner comprising a frame movably attached to the base, the frame having a data transducer head and at least one permanent magnet fixed thereto; and
a planar coil fixed to the base, the planar coil having a major surface disposed adjacent to the at least one permanent magnet and substantially parallel to at least a portion of a support surface of the data transducer head, wherein the frame moves relative to the base and planar coil in response to energizing the planar coil.

2. The actuator of claim 1, further comprising a flexure member attaching the frame to the base in a movable relationship, wherein the flexure member has a plane of flexion substantially perpendicular to the major surface of the planar coil.

3. The actuator of claim 1, further comprising a first flexure positioned to a first side of the coil and a second flexure positioned to a second side of the coil.

4. The actuator of claim 3, wherein the first and second flexures extend substantially perpendicularly to the major surface of the coil.

5. The actuator of claim 1, wherein the at least one permanent magnet includes at least two magnets configured having a planar surface substantially parallel to the major surface of the planar coil.

6. The actuator of claim 1, wherein the major surface of the planar coil is within 15 degrees of parallel with the at least a portion of the support surface.

7. The actuator of claim 1, wherein the planar coil is disposed at least partially at a center of mass of the positioner.

8. The actuator of claim 1, wherein the planar coil is operable to produce, when energized, a magnetic field substantially aligned with a center of mass of the positioner.

9. The actuator of claim 8, wherein the planar coil is operable to produce, when energized, a magnetic field aligned within 0.3 inches of the center of mass of the positioner.

10. The actuator of claim 1, wherein a center of mass of the positioner is located at the intersection of two axes, the two axes defining a plane substantially parallel to the major surface of the coil, and a third axis passes through the center of mass of the positioner, is perpendicular to the plane, and is substantially aligned with the direction of magnetic force produced by the planar coil when energized.

11. A tape drive comprising the head actuator of claim 1.

12. A tape head actuator, comprising:
a base;
a tape head positioner, the tape head positioner comprising:
a tape head operable to access a data storage tape; and
at least one magnet fixed with respect to the tape head;
a planar coil attached to the base and adjacent the at least one magnet, the planar coil having a major surface substantially parallel to a portion of a support surface of the tape head;
a first flexure positioned to a first side of the coil, having a proximal end attached to the base and a distal end attached to the positioner; and
a second flexure positioned to a second side of the coil, having a proximal end attached to the base and a distal end attached to the positioner.

13. The tape head actuator of claim 12, wherein the flexure members each have a plane of flexion substantially perpendicular to the major surface of the planar coil.

14. The tape head actuator of claim 12, wherein the flexure members each have a major surface substantially perpendicular to the major surface of the planar coil.

15. The tape head actuator of claim 12, wherein the at least one magnet defines a planar surface substantially parallel to the major surface of the planar coil.

16. The tape head actuator of claim 12, wherein the major surface of the planar coil is within 15 degrees of parallel with the portion of the support surface.

17. The tape head actuator of claim 12, wherein the planar coil is disposed at least partially at a center of mass of the tape head positioner.

18. The tape head actuator of claim 12, wherein the planar coil is operable to produce, when energized, a force substantially aligned with a center of mass of the tape head positioner.

19. The tape head actuator of claim 18, wherein the planar coil is operable to produce, when energized, a force aligned within 0.3 inches of the center of mass of the tape head positioner.

20. The tape head actuator of claim 12, wherein a center of mass of the positioner is located at the intersection of two axes, the two axes defining a plane substantially parallel to the major surface of the coil, and a third axis passes through the center of mass of the tape head positioner, is perpendicular to the plane, and is substantially aligned with the direction of magnetic force produced by the planar coil when energized.

21. The tape head actuator of claim 12, wherein the base comprises a coarse positioner body.

22. A tape drive comprising the tape head actuator of claim 12.
